(19) United States
(12) Patent Application Publication
(10) Pub. No.: US 2008/0064279 A1
(43) Pub. Date: Mar. 13, 2008

(54) DENSIFIED CONDUCTIVE MATERIALS AND ARTICLES MADE FROM SAME

(75) Inventors: Rhesa M. Browning, Austin, TX (US); Jeffrey A. Lim, Austin, TX (US); Charles Mitchell, Austin, TX (US); Sywong Ngin, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/764,873

(22) Filed: Jun. 19, 2007

Related U.S. Application Data
(60) Provisional application No. 60/825,216, filed on Sep. 11, 2006.

(51) Int. Cl. B32B 27/04

(52) U.S. Cl. 442/115; 442/110

(57) ABSTRACT

Disclosed are electromagnetically conductive articles comprising a densified core material and at least one electromagnetically conductive material. Also disclosed are electromagnetically conductive articles comprising at least one layer of a densified fabric material at least a portion of at least one surface of which is plated with one or more electromagnetically conductive particulate materials. Methods of making and using such electromagnetically conductive articles are also provided.

### CROSS REFERENCE TO RELATED APPLICATION

This application claims the benefit of U.S. Provisional Patent Application No. 60/825,216, filed Sep. 11, 2006, the disclosure of which is incorporated by reference herein in its entirety.

### TECHNICAL FIELD

The present invention generally relates to electromagnetically conductive articles, including tapes and other articles useful for shielding electromagnetic radiation. The invention also generally relates to methods for making and using electromagnetically conductive articles.

### BACKGROUND

Devices of many kinds and types emit electronic or electromagnetic radiation. These sources of radiation, which are becoming increasingly prevalent in today's environment, can cause myriad problems with other electronic devices. Electromagnetic radiation emitted from circuits of some electronic appliances can, for example, cause interference or malfunction in other electronic devices or peripheral components near the source circuits. Deleterious effects of this potential interference can include a degradation of performance in an affected device, deterioration of electronic images from generated electronic noise or a general reduction in the useful lifespan of electronic devices.

Various approaches have been applied to protect electronic devices from the effects of undesired or excess environmental electromagnetic radiation. One such approach includes the use of a shield or shielding material to protect the internal components of a device. Generally, such shields or shielding materials act to conduct electromagnetic radiation away from an area in which the protected components are housed. Metal plates, metal plated fabrics, conductive paints, conductive tapes and conductive polymeric-based materials are among the materials that have been adapted for shielding applications.

Because environmental electromagnetic radiation can be observed across a wide frequency spectrum, the effectiveness of a conductive shielding material is determined by its ability to conduct radiation along a desired frequency band for which protection is most desired. While the frequency band for which such protection is sought can depend on any particular application, broad shielding capability is generally desired. Most typically, the effectiveness of a shielding material is measured by its ability to prevent radiation from passing through it across a frequency range from about 100 MHz to about 1000 MHz.

The effectiveness of a shielding material can be measured quantitatively by its “Shielding Effectiveness” (or “SE”) which, expressed in decibels (db), is defined by the ratio of either the power or voltage transmitted through the measured material compared with the power or voltage received without the material present. The relationship is expressed as follows:

$$SE = 10 log ( \frac{{P}_{1}}{{P}_{2}} )$$

$$SE = 20 log ( \frac{{V}_{1}}{{V}_{2}} ) .$$

where:
P₁=power received with the material present between the source and a point adjacent to the material;
P₂=power received without the material present between the source and a point adjacent to the material;
V₁=voltage received with the material present between the source and a point adjacent to the material;
V₂=voltage received without the material present between the source and a point adjacent to the material.

Because shielding materials are generally used to protect small electronic components, there is typically a desire to construct protective articles made of the materials as thin, light weight tapes or films. Such tapes or films can be used to encase or enclose one or more surfaces of an area for which protection is desired. The tapes and films often include an adhesive (such as a pressure sensitive adhesive) for ease of application to the surface of a housing for an electronic component, e.g., a printed circuit board or a radio frequency identification (RFID) device.

### SUMMARY OF THE INVENTION

In one aspect, the present invention provides an electromagnetically conductive article comprising a densified core material and at least one electromagnetically conductive material.

In another aspect, the invention provides an electromagnetically conductive article comprising at least one layer of a densified fabric material at least a portion of at least one surface of which is plated with one or more electromagnetically conductive particulate materials.

In still another aspect, the invention provides an electromagnetically conductive article comprising at least one layer of a fabric material at least a portion of which is calendered and at least a portion of which is plated with one or more electromagnetically conductive materials.

Also provided is an electromagnetically conductive article comprising a fabric plated with at least one electromagnetically conductive metal wherein the air permeability of the fabric as measured along a plane dissecting the fabric through its smallest width is no greater than about 0.5 m³/min.

The present invention also provides methods of making electromagnetically conductive articles. In one embodiment the method of making such an electromagnetically conductive article comprises:

(a) densifying a fabric; and

(b) plating the fabric with one or more electromagnetically conductive materials to form an electromagnetically conductive article.

The electromagnetically conductive articles of the invention, by employing densified fabric core materials, can be used to provide effective shielding against undesired electromagnetic radiation with relatively thinner constructions, particularly when the articles are made into sheets, tapes or films. In another aspect, the invention provides an ability to construct electromagnetically shielding articles exhibiting comparable or improved shielding effectiveness with smaller cross-sectional dimensions compared with those shielding materials made without a densified fabric core.

### BRIEF DESCRIPTION OF THE DRAWINGS

FIG. 1 provides a comparison graph of the shielding effectiveness of a densified conductive article and two uncalendered articles.

FIG. 2 provides a comparison graph of the air permeability, shielding effectiveness and surface resistivity of various densified and undensified conductive articles.

FIG. 3 provides a comparison graph of the results of taber abrasion testing of various densified and undensified conductive articles.

FIG. 4 provides a comparison graph of the shielding effectiveness of a densified (calendered) article and an undensified (uncalendered) article.

FIG. 5 provides a comparison graph of the shielding effectiveness of a densified (calendered) article and an undensified (uncalendered) article.

### DETAILED DESCRIPTION OF PREFERRED EMBODIMENTS

The conductive articles of the invention contain a densified core material generally made of a nonwoven or woven fabric. The conductive articles additionally contain an effective amount of at least one electromagnetically conductive material. The electromagnetically conductive material may include one or more electromagnetically conductive organic or inorganic particulate materials, including metals such as copper or nickel, or organic particulates such as carbon black. The fabric, which preferably is made in a flexible sheet-like form, may optionally include an adhesive on one or more of its surfaces. The adhesive may include an additional amount of one or more electromagnetically conductive materials. The article may include a seal coat opposite the surface or side on which an adhesive layer is placed. Alternatively, the article may include a seal coat applied to each side of the densified fabric. The article may also include a release layer or liner adjacent the adhesive.

The densified core materials of the invention can include any woven or nonwoven fabric or fabric-like material that includes a degree of interstitial separation or space within the fibers or threads making up the fabric-like material. Although webs or sheets of natural or synthetic woven fibers or threads are useful in the articles of the invention nonwoven materials will generally be preferred because of their relative cost and ease of manufacture.

Fibers having a diameter of about 100 microns (μm) or less, and particularly so-called “microfibers” having a diameter of no greater than about 50 μm, are useful in the manufacture of nonwoven web-based materials. These fibers and microfibers are typically used in the form of nonwoven webs that can be used in the manufacture of a wide variety of products, including face masks and respirators, air filters, vacuum bags, oil and chemical spill sorbents, thermal insulation, first aid dressings, medical wraps, surgical drapes, disposable diapers, wipe materials and the like. Nonwoven webs of fibers are particularly desirable because they provide a material with a high surface area and generally have a high degree of porosity.

The fibers can be made by a variety of melt processes, including by known spunbond and melt-blown processes. In a spunbond process, fibers are extruded from a polymer melt stream through multiple banks of spinnerets onto a rapidly moving, porous belt thereby generally forming an unbonded web. This unbonded web is then passed through a bonder (typically a thermal bonder) that bonds some of the fibers to adjacent fibers and provides integrity to the web. In a typical melt-blown process, fibers are extruded through fine orifices using high velocity air attenuation onto a rotating drum to form an autogeneously bonded web. In contrast to a typical spunbond process, a melt-blown process generally requires no further processing. Both of these processes are detailed in a variety of publications, including by Wente in “Superfine Thermoplastic Fibers,” Industrial Engineering Chemistry, vol. 48, pp. 1342 et seq. (1956).

Any material capable of forming a fiber by melt processing, including in the processes described immediately above may be employed in making a suitable nonwoven material. Useful, generally preferred exemplary polymeric materials include polyesters such as polyethylene terephthalate; polyalkylenes such as polyethylene or polypropylene; polyamides such as nylon 6; polystyrenes; and polyarylsulfones. Also useful are slightly elastomeric materials including olefinic elastomeric materials such as some ethylene/propylene or ethylene/propylene/diene elastomeric copolymers and other ethylenic copolymers such as ethylene vinyl acetates.

The woven or nonwoven core material is densified prior to its incorporation into the finished articles of the invention. Densification refers to any process by which the interstitial area or space in the woven or nonwoven material is reduced by the application of pressure, or by the application or removal of heat, or by both the application of pressure and the application or removal of heat, or by any other method of reducing interstices in the woven or nonwoven material. Densification may be accomplished, for example, by standard calendering processes whereby a web of the core material is passed through a pair or a series of rollers which are held under pressure. The roller may be either heated or cooled. The core material may also be pressed by the application of heated or cooled plates such as with the use of a Flatten Press.

Densification, once achieved, may be evidenced in any one or more of several ways, including by one or more of the following: a reduction in the thickness of the article, an increase in the density of the article, a reduction in air permeability, a reduction in porosity or a change in the surface resistivity of the core material. Importantly, no absolute threshold can be defined for the thickness, density, permeability, porosity or surface resistivity of the core materials before and after densification. Because the invention provides a relative increase in the performance of electromagnetically conductive articles, the core materials of the articles of the invention will generally exhibit a relative reduction in one or more of its cross-sectional thickness, air permeability, porosity or surface resistivity or an increase in its density after densification. This change provides for the ability, once constructed, for the articles to exhibit the same or even improved electromagnetic radiation shielding properties compared with articles constructed of non-densified materials.

By way of example, a typical thickness of the woven or nonwoven core material can range from about 1 to about 10 mil, more typically from about 3 to 8 mil. Generally, depending on the material chosen for the woven or nonwoven core, the core will be calendered, pressed or otherwise processed (i.e., densified) to reduce its thickness by about 10 to 80 percent, more preferably from about 25 to 60 percent. When so densified, the air permeability of the core material (and/or an article made of the material) will generally be reduced. Typically, the air permeability of the woven or nonwoven core material measured along a plane dissecting the material through its smallest cross-sectional dimension will be no greater than about 0.5 m³/min, preferably no greater than about 0.25 m³/min and more preferably no greater than about 0.2 m³/min.

The conductive articles of the invention also include one or more electromagnetically conductive organic or inorganic particulate materials disposed on or within the densified core woven or nonwoven material. Useful electromagnetically conductive particulates include: noble metals; non-noble metals; noble metal-plated noble or non-noble metals; non-noble metal-plated noble or non-noble metals; noble or non-noble metal plated non-metals; conductive non-metals; conductive polymers; and mixtures thereof. More particularly, the conductive particulates may include noble metals such as gold, silver, platinum; non-noble metals such as nickel, copper, tin, aluminum, and nickel; noble metal-plated noble or non-noble metals such as silver-plated copper, nickel, aluminum, tin, or gold; non-noble metal-plated noble and non-noble metals such as nickel-plated copper or silver; noble or non-noble metal plated non-metals such as silver or nickel-plated graphite, glass, ceramics, plastics, elastomers, or mica; conductive non-metals such as carbon black or carbon fiber; conductive polymers such as polyacetylene, polyaniline, polypyrrole, polythiophene, poly sulfurnitride, poly(p-phenylene), poly(phenylene sulfide) or poly(p-phenylenevinylene); and mixtures thereof. Generally preferred will be those noble and non-noble metals (and mixtures of such metals) that exhibit conductivity to electromagnetic radiation across a wide frequency spectrum. Because of their relative abundance, specific preferred metals include silver, nickel and copper and mixtures thereof.

The electromagnetically conductive material (or mixture of materials) may be applied to the woven or nonwoven core material by coating or plating (electro- or chemically) an effective amount of the conductive material onto the core material. The conductive material may be applied to the core material before or after densification. Any amount of conductive material may be employed that provides a desired amount of shielding property, and this amount will necessarily vary based on the chosen electromagnetically conductive material and on the application to which the article will be employed. Where the chosen electromagnetically conductive material is a metal, exemplary application of the metal to the core material can range from 5 to 100 g/m², from 10 to 80 g/m² or from 20 to 50 g/m².

The articles of the invention can include an adhesive layer on at least a portion of one exterior surface of the woven or nonwoven core material or layer. Where the core material is in the form of a substantially flat web or sheet, an adhesive layer can be placed on at least a portion of one or both of the top and bottom surfaces. Any suitable adhesive may be employed for this purpose, and the type or composition of the adhesive will be chosen to be compatible with the substrate onto which the article will be adhered. Generally, when the articles are to be used for the protection of electronic components, a suitable electronics grade adhesive will be selected. Any among numerous known pressure sensitive adhesives (or “PSAs”) may be used, including natural or synthetic tackified rubber PSAs, repositionable PSAs or acrylic-based PSAs. Generally preferred will be acrylic-based adhesives and specifically those containing at least fifty percent by weight or more acrylate functionality. One suitable acrylic-based adhesive is disclosed in U.S. Pat. No. Re 24,906 which describes a 95.4/4.5 weight percent isooctyl acrylate/acrylic acid copolymer pressure sensitive adhesive. Also useful are photopolymerizable acrylic-based adhesives. The selected adhesive composition may be applied to one or more surfaces of the woven or nonwoven core material by any suitable known method, including by solvent or holt melt coating or processing techniques.

The adhesive composition may also be formulated to contain one or more electromagnetically conductive materials. When added to the adhesive, such materials can aid in further enhancing the shielding or protective properties of the article. The electromagnetically conductive material chosen for incorporation into the adhesive may be the same or may be different from that chosen to be used with the densified core material. Generally, when present, the conductive material will be added to the adhesive to constitute between 0 and 75 percent by weight of the adhesive composition, preferably from 10 to 50 weight percent. When the electromagnetically conductive article is made in the form of an adhesive tape, a release liner may also be applied to the outer surface of the adhesive. The adhesive composition may also include other functional components or additives such as one or more corrosion inhibitors or one or more corrosion resistance additives.

A seal or top coating may optionally be applied to the outer surface of the electromagnetically conductive article. This coating can be used to protect the woven or nonwoven core material and seal or help secure the conductive material within the article. Any material that may be used to seal the core material may be used as a top or seal coat. One such useful material is a vinyl polymer and specifically a clear or substantially clear vinyl acetate-vinyl alcohol-vinyl chloride copolymer. The seal or top coat may be coated onto the core substrate to any desired weight, but will generally be applied in an amount sufficient to fill or substantially fill the surface voids in the core material to provide a substantially smooth surface. As with the adhesive, the seal or top coat can also be formulated to include an additional amount of one or more electromagnetically conductive materials. When added to the top coat (as when added to the adhesive) such materials can aid in further enhancing the shielding or protective properties of the article. The electromagnetically conductive material chosen for incorporation into the top coat may be the same or may be different from that chosen to be used with the densified core material and/or the adhesive. Generally, when present, the conductive material will be added to the adhesive to constitute between 0 and 75 percent by weight of the coating composition, more preferably from 10 to 50 weight percent.

Any number of conventional or optional additives or adjuvants may be added to one or more of the layers or components of the electromagnetically conductive articles of the invention. Anti-oxidants, ultraviolet stabilizers, and/or corrosion inhibitors may, for example, be added to the adhesive or seal coat (or both) to provide protection for the electromagnetically conductive articles. Other functional or nonfunctional additives or adjuvants may similarly be added.

The articles of the invention can be used in any application where an electromagnetic shield is desired. The articles, for example, can be formed into tapes and used for shielding applications relating to electronic devices, circuits, RFID devices such as RFID tags, or other devices benefiting from electromagnetic shielding. The articles may also be used to contain, block or mask radiation emitted from the devices or components which they might be used to shield. When used in the application of shielding a device, the electromagnetically conductive article or densified core material thereof should be positioned in close proximity to the device, such as, for example, within 25 mm from the device, and preferably less than 5 mm from the device.

By employing a densified woven or nonwoven core material, the articles of the invention provide several potential advantages. By providing for a more efficient and concentrated use of one or more electromagnetically conductive materials within the densified interstitial area of the woven or nonwoven core substrate material, the articles provide for a greater shielding effectiveness per unit volume of the article. This provides an ability for the construction of thinner shielding articles that possess equivalent or improved shielding properties compared with articles that employ nondensified core substrate materials. The articles of the invention also generally provide improved surface resistivities and reduced physical and/or electrical permeabilities (i.e., reduced current leakage, improved electrical conduit properties and improved electrical sealing properties). The densified core materials can provide more consistent cross-sectional dimensions (e.g., thicknesses) and provide enhanced adhesion to substrates to which they may be attached. A reduction in porosity and/or permeability of the core materials also allows for more efficient use of adhesive and top coat materials. Encapsulation of the electromagnetically conductive materials within the densified core materials reduces corrosion and aids in the prevention of other deleterious effects of moisture and humidity. The densified materials are also less susceptible to physical abrasion and fraying, provide for the more effective addition of pigments and other additives and provide a greater degree of durability.

### EXAMPLES

### Samples

Five product samples were prepared for testing and evaluation as provided in Table 1 below:

TABLE 1

| Sample | Description |
|---|---|
| 1 | 6.0 mil uncalendered product |
| 2 | 6.0 mil uncalendered core material |
| 3 | 4.0 mil uncalendered product |
| 4 | 4.0 mil calendered product |
| 5 | 4.0 mil calendered core material |

The 6.0 mil uncalendered core material sample and the 4.0 mil calendered core material sample (Sample Nos. 2 and 5 respectively) were prepared by plating the core material with copper and nickel metals on a polyethylene terephthalate (PET) fabric. The 6.0 mil uncalendered product sample, 4.0 mil uncalendered product sample and 4.0 mil calendered product sample (Sample Nos. 1, 3 and 4 respectively) were prepared by first plating copper and nickel metals on PET fabric. For these samples (Sample Nos. 1, 3, and 4 respectively), an acrylic adhesive loaded with nickel particles was subsequently laminated to one side of the PET fabric and a seal coat consisting of a vinyl binder and silver was laminated to the other side of the PET fabric.

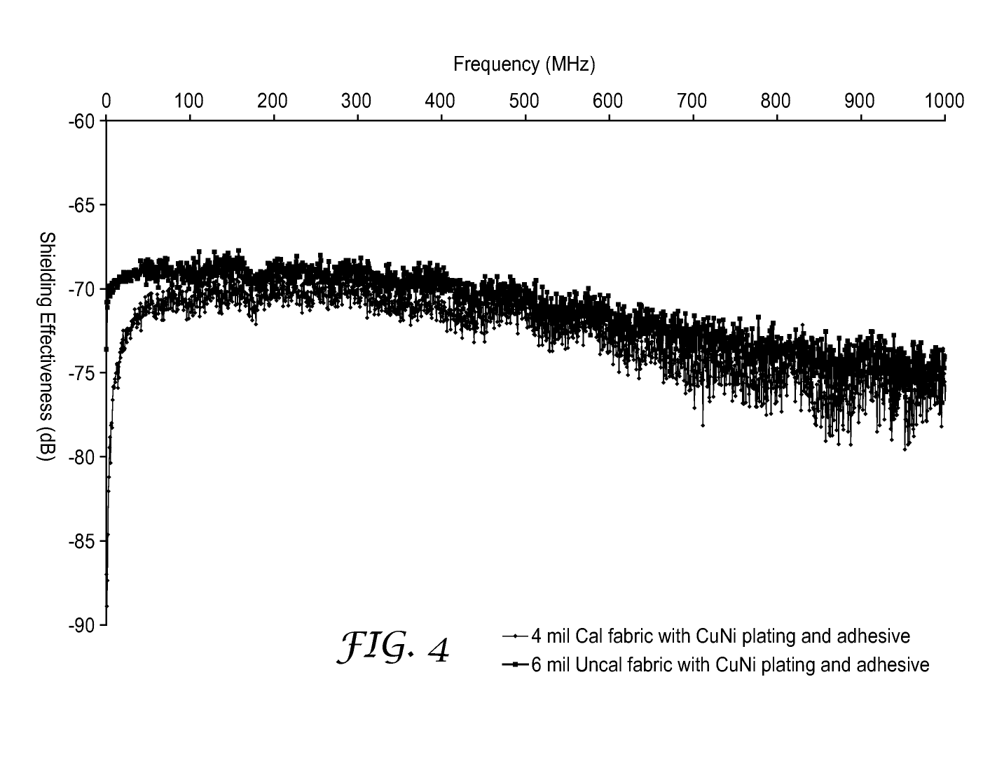

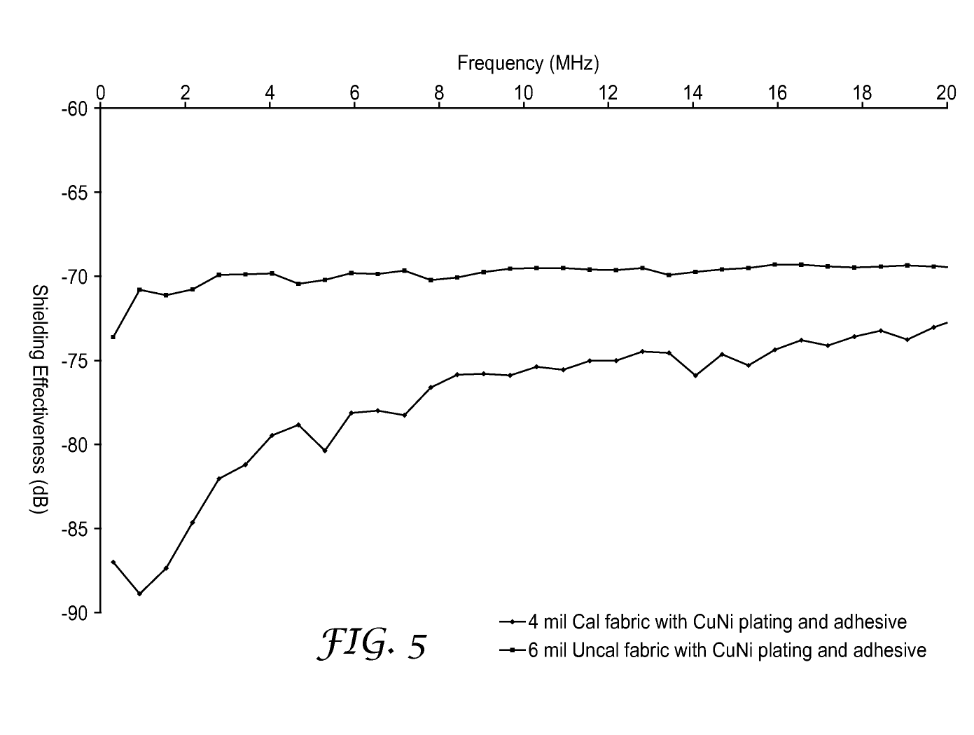

The graphs of FIG. 4 and FIG. 5 show a comparison of two samples: a 4 mil calendered core material with copper and nickel plating and adhesive vs. a 6 mil uncalendered core material with copper and nickel plating and adhesive.

### Shielding Effectiveness

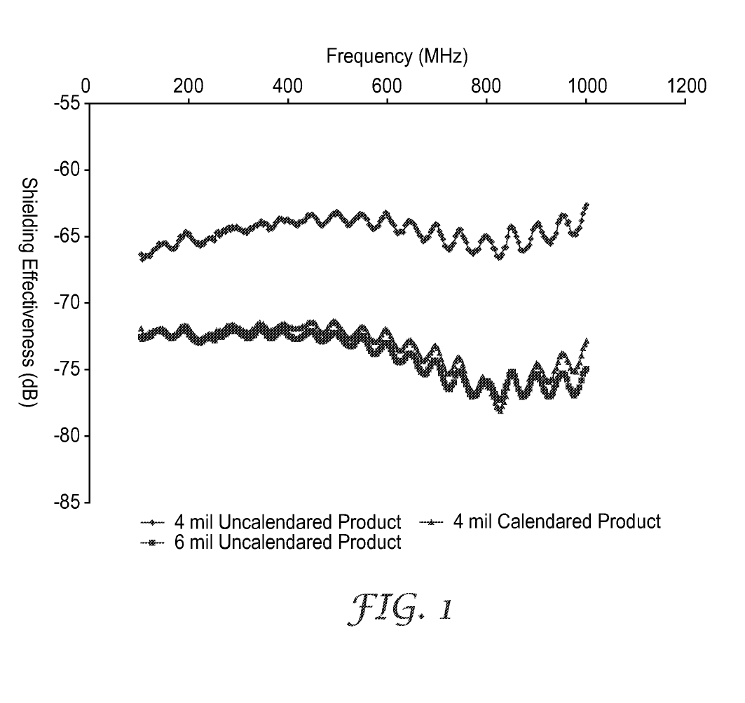

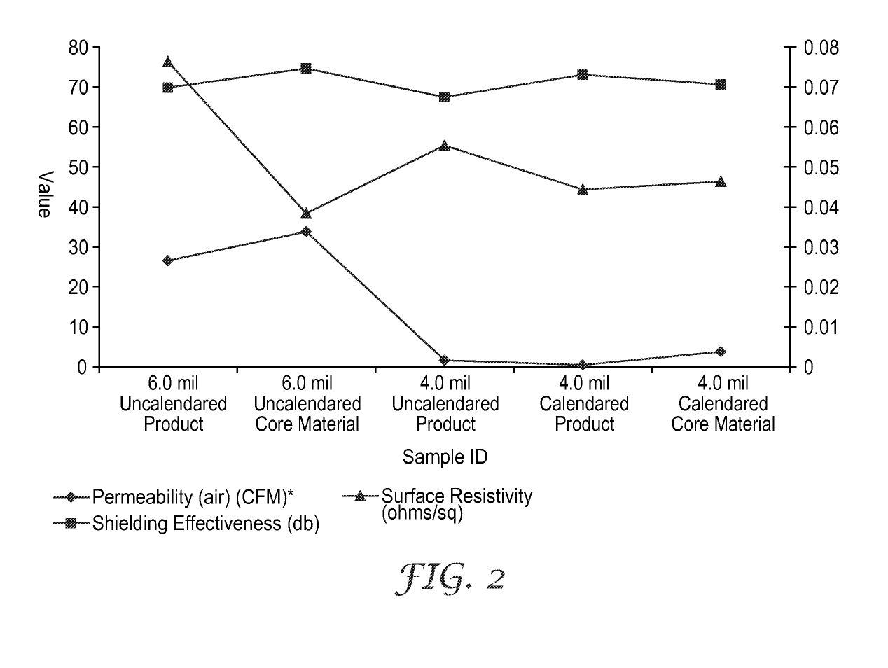

Each of the Samples were evaluated for shielding effectiveness according to ASTM D4935-99 using a Hewlett-Packard™ 8510 Network Analyzer and Transverse Electromagnetic (TEM) cell. The graph shown in FIG. 1 shows values collected over the frequency range of 100 MHz to 1000 MHz. The values shown in Table 3 and in the graph of FIG. 2 are the average of the individual values collected over the frequency range of 100 MHz to 1000 MHz. The graph shown in FIG. 4 shows values collected over the frequency range of 0.3 MHz to 1000 MHz. The graph shown in FIG. 5 shows values collected over the frequency range of 0.3 MHz to 20 MHz.

### Surface Resistivity

Surface resistivity measurements were performed on the Samples according to ASTM F43 using a Delcom™ 717 eddy current detection system and/or a four-point measurement system. The results are shown in Table 3 and in FIG. 2.

### Air Permeability

Air permeability measurements were performed on the Samples using a Frazier™ 2000 Differential Pressure Air Permeability Tester. The results are shown below in Tables 2 and 3 and in FIG. 2.

TABLE 2

| | | | | Opening |
|---|---|---|---|---|
| | Permeability | | Nzl Size | Diameter |
| Sample No. | (ft³/min) | Targeting (in. H₂O) | (mm) | (in.) |
| 1 | 26.2 | Sensor 1 - 0.50 | 4.0 | 2.75 |
| 2 | 33.4 | Sensor 1 - 0.50 | 4.0 | 2.75 |
| 3 | 1.3 | Sensor 1 - 10.00 | 1.0 | 2.75 |
| 4 | less than 0.1 | Sensor 1 - 10.00 | 1.0 | 2.75 |
| 5 | 3.4 | Sensor 1 - 0.50 | 1.4 | 2.75 |

### Taber Abrasion

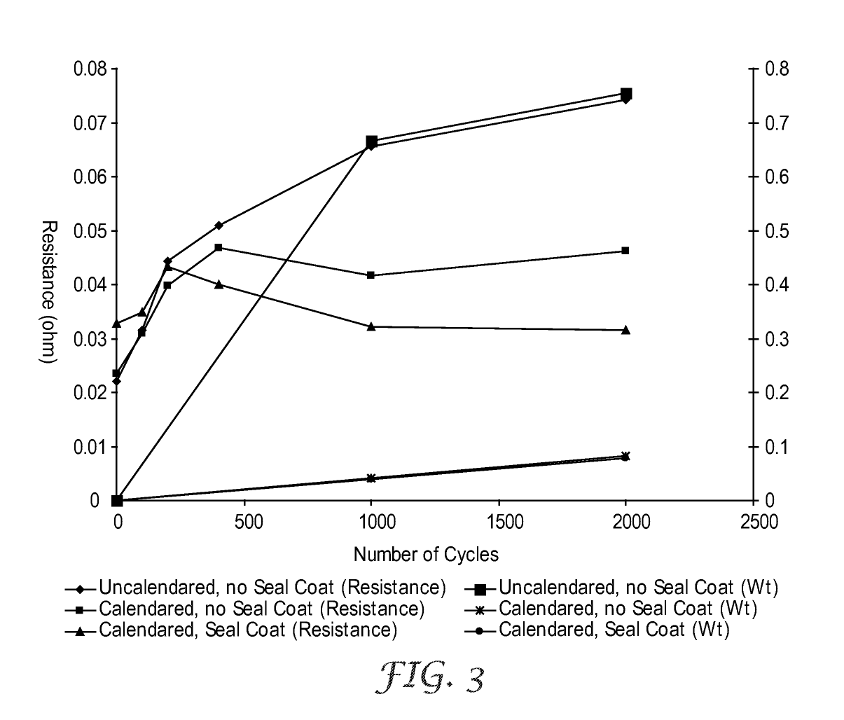

Each of the Samples were tested for taber abrasion using a Teledyne™ Model 503 abrasion tester was used with CS-5 felt wheels. Prior to testing, each Sample was weighed and measured for initial resistance. The Samples were weighed again after the completion of 1000 and 2000 cycles to determine weight loss and measured for resistance after the completion of 100, 200, 400, 1000, and 2000 cycles. The results are shown in FIG. 3.

TABLE 3

| | Air Permeability | Shielding | Surface Resistivity |
|---|---|---|---|
| Sample No. | (ft³/min)* | Effectiveness (db) | (ohms/sq) |
| 1 | 26.2 | 69.5 | 0.076 |
| 2 | 33.4 | 74.6 | 0.038 |
| 3 | 1.3 | 67.1 | 0.055 |
| 4 | 0.1 | 72.7 | 0.044 |
| 5 | 3.4 | 70.3 | 0.046 |

*cubic feet of square feet of sample per minute

We claim:

1. An electromagnetically conductive article comprising a densified core material and at least one electromagnetically conductive material.

2. The article of claim 1 wherein the densified core material is a nonwoven fabric, and wherein the densified core material is positioned within close proximity to an RFID device.

3. The article of claim 2 wherein the nonwoven fabric comprises a thermoplastic polymeric material.

4. The article of claim 3 wherein the thermoplastic polymeric material includes a polyester.

5. The article of claim 3 wherein the thermoplastic polymeric material includes polyethylene terephthalate.

6. The article of claim 2 wherein the nonwoven fabric is made from a melt processable polymeric material selected from the group consisting of polyesters; polyalkylenes; polyamides; polystyrenes; and polyarylsulfones.

7. The article of claim 1 wherein the densified core material comprises a fabric made of a natural fiber material.

8. The article of claim 1 wherein the densified core material comprises a woven fabric.

9. The article of claim 1 wherein the electromagnetically conductive material includes one or more materials selected from the group consisting of: noble metals; non-noble metals; noble metal-plated noble or non-noble metals; non-noble metal-plated noble or non-noble metals; noble or non-noble metal plated non-metals; conductive non-metals; and conductive polymers.

10. The article of claim 1 wherein the electromagnetically conductive material includes one or more materials selected from the group consisting of: gold; silver; platinum; nickel; copper; tin; aluminum; silver-plated copper, nickel, aluminum, tin, or gold; nickel-plated copper or silver; silver or nickel-plated graphite, glass, ceramics, plastics, elastomers, or mica; carbon black or carbon fiber; polyacetylene; polyaniline; polypyrrole; polythiophene; polysulfurnitride; poly(p-phenylene); poly(phenylene sulfide) or poly(p-phenylenevinylene); and mixtures thereof.

11. The article of claim 1 wherein the electromagnetically conductive material includes copper and nickel.

12. The article of claim 1 wherein at least a portion of at least one surface of the article is coated with elemental silver.

13. The article of claim 1 wherein the densified core material is calendered.

14. The article of claim 1 wherein the densified core material is pressed.

15. The article of claim 1 further comprising a layer of adhesive disposed on at least a portion of at least one surface of the article.

16. The article of claim 15 wherein the adhesive contains nickel.

17. An electromagnetically conductive article comprising at least one layer of a densified fabric material at least a portion of at least one surface of which is plated with one or more electromagnetically conductive particulate materials.

18. The article of claim 17 wherein the densified fabric is made from a melt processable polymeric material selected from the group consisting of polyesters; polyalkylenes; polyamides; polystyrenes; and polyarylsulfones, and wherein the densified fabric material is positioned within close proximity to an RFID device.

19. The article of claim 17 wherein the electromagnetically conductive material includes one or more materials selected from the group consisting of: noble metals; non-noble metals; noble metal-plated noble or non-noble metals; non-noble metal-plated noble or non-noble metals; noble or non-noble metal plated non-metals; conductive non-metals; and conductive polymers.

20. The article of claim 17 wherein the electromagnetically conductive material includes one or more materials selected from the group consisting of: gold; silver; platinum; nickel; copper; tin; aluminum; silver-plated copper, nickel, aluminum, tin, or gold; nickel-plated copper or silver; silver or nickel-plated graphite, glass, ceramics, plastics, elastomers, or mica; carbon black or carbon fiber; polyacetylene; polyaniline; polypyrrole; polythiophene; polysulfurnitride; poly(p-phenylene); poly(phenylene sulfide) or poly(p-phenylenevinylene); and mixtures thereof.

21. The article of claim 17 wherein the electromagnetically conductive material includes copper and nickel.

22. The article of claim 17 wherein at least a portion of at least one surface of the article is coated with elemental silver.

23. The article of claim 17 wherein the densified fabric is calendered.

24. The article of claim 17 wherein the densified fabric is pressed.

25. The article of claim 17 further comprising a layer of adhesive disposed on at least a portion of at least one surface of the article.

26. The article of claim 25 wherein the adhesive contains nickel.

27. An electromagnetically conductive article comprising at least one layer of a fabric material at least a portion of which is calendered and at least a portion of which is plated with one or more electromagnetically conductive materials.

28. An electromagnetically conductive article comprising a fabric plated with at least one electromagnetically conductive material wherein the air permeability of the fabric as measured along a plane dissecting the fabric through its smallest width is no greater than about 0.5 m³/min.

29. The article of claim 28 wherein the air permeability of the fabric as measured along a plane dissecting the fabric through its smallest width is no greater than about 0.25 m³/min.

30. The article of claim 28 wherein the air permeability of the fabric as measured along a plane dissecting the fabric through its smallest width is no greater than about 0.2 m³/min.

31. A method of making an electromagnetically conductive article comprising:
(a) densifying a fabric; and
(b) plating the fabric with one or more electromagnetically conductive materials.

32. The method of claim 31 wherein the densifying comprises calendering, and further comprising positioning the fabric within close proximity to an RFID device.

33. The method of claim 31 further comprising coating at least a portion of the fabric with a layer of elemental silver.

34. The method of claim 31 further comprising coating a layer of adhesive onto at least one surface of the fabric.

35. The method of claim 34 wherein the adhesive contains nickel.
